(19) United States
(12) Patent Application Publication
(10) Pub. No.: US 2022/0319245 A1
(43) Pub. Date: Oct. 6, 2022

(54) DRIVING DIAGNOSIS DEVICE AND DRIVING DIAGNOSIS METHOD

(71) Applicant: Toyota Jidosha Kabushiki Kaisha, Toyota-shi Aichi-ken (JP)

(72) Inventor: Yukiya Kushibiki, Gifu-shi Gifu-ken (JP)

(21) Appl. No.: 17/591,946

(22) Filed: Feb. 3, 2022

(30) Foreign Application Priority Data
Mar. 31, 2021 (JP) 2021-060721

(51) Int. Cl. G07C 5/02; G07C 5/00; G07C 5/08

(52) U.S. Cl. CPC G07C 5/02; G07C 5/008; G07C 5/085

(57) ABSTRACT

A driving diagnosis device includes an event identification unit that is able to acquire, from a vehicle, a first detection value indicating that an accelerator pedal provided on the vehicle is stepped on and a second detection value indicating that a brake pedal provided on the vehicle is stepped on, and that determines whether the accelerator pedal and the brake pedal are simultaneously stepped on based on the acquired first detection value and the acquired second detection value.

### CROSS-REFERENCE TO RELATED APPLICATION

This application claims priority to Japanese Patent Application No. 2021-060721 filed on Mar. 31, 2021, incorporated herein by reference in its entirety.

### BACKGROUND

### 1. Technical Field

The present disclosure relates to a driving diagnosis device and a driving diagnosis method.

### 2. Description of Related Art

The following Japanese Patent No. 3593502 (JP 3593502 B) and Japanese Patent No. 6648304 (JP 6648304 B) disclose a driving diagnosis device that performs a calculation based on a detection value that is a physical amount that changes based on at least one of traveling, steering, and braking of a vehicle and that acquires a driving diagnosis result.

### SUMMARY

The driving diagnosis device of JP 3593502 B and JP 6648304 B has room for improvement in the driving diagnosis regarding an operation of an accelerator pedal and a brake pedal.

In consideration of the above facts, an object of the present disclosure is to acquire a driving diagnosis device and a driving diagnosis method capable of motivating a driver to refrain from simultaneously stepping on an accelerator pedal and a brake pedal.

A driving diagnosis device according to a first aspect includes: an event identification unit that is able to acquire, from a vehicle, a first detection value indicating that an accelerator pedal provided on the vehicle is stepped on and a second detection value indicating that a brake pedal provided on the vehicle is stepped on, and that determines whether the accelerator pedal and the brake pedal are simultaneously stepped on based on the acquired first detection value and the acquired second detection value.

The event identification unit of the driving diagnosis device according to the first aspect is able to acquire, from a vehicle, a first detection value indicating that an accelerator pedal provided on the vehicle is stepped on and a second detection value indicating that a brake pedal provided on the vehicle is stepped on. Further, the event identification unit determines whether the accelerator pedal and the brake pedal are simultaneously stepped on based on the acquired first detection value and the acquired second detection value.

Thus, the driving diagnosis device according to the first aspect can motivate the driver that has recognized the determination result of the event identification unit that the accelerator pedal and the brake pedal are stepped on simultaneously to refrain from simultaneously stepping on the accelerator pedal and the brake pedal thereafter.

In the driving diagnosis device according to the disclosure indicated in a second aspect, in the disclosure according to the first aspect, further comprising a transmission-reception unit that is able to receive the first detection value and the second detection value from the vehicle via the Internet and that is able to transmit the acquired first detection value and the acquired second detection value to the event identification unit.

In the disclosure according to the second aspect, the driving diagnosis device further includes a transmission-reception unit that is able to receive the first detection value and the second detection value from the vehicle via the Internet and that is able to transmit the acquired detection value to the event identification unit. Thus, for example, a driving diagnosis device can be constructed as a cloud computing system.

In the driving diagnosis device according to the disclosure indicated in a third aspect, in the disclosure according to the first or second aspect, included is a database unit that stores information of whether the accelerator pedal and the brake pedal determined by the event identification unit are stepped on simultaneously and that is connected to the Internet.

In the disclosure according to the third aspect, information of whether the accelerator pedal and the brake pedal determined by the event identification unit are stepped on simultaneously is stored in the database unit that is connected to the Internet. Thus, a person who can access the data base can develop an application that uses this information.

A driving diagnosis method of the disclosure according to a fourth aspect includes: a step of acquiring, from a vehicle, a first detection value indicating that an accelerator pedal provided on the vehicle is stepped on and a second detection value indicating that a brake pedal provided on the vehicle is stepped on; and a step of determining whether the accelerator pedal and the brake pedal are simultaneously stepped on based on the acquired first detection value and the acquired second detection value.

As described above, the driving diagnosis device and the driving diagnosis method of the present disclosure has an effect of being able to motivate a driver to refrain from simultaneously stepping on an accelerator pedal and a brake pedal.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a vehicle capable of transmitting a detection value to a driving diagnosis device according to an embodiment;

FIG. 2 is a diagram showing the driving diagnosis device, the vehicle, and a mobile terminal according to the embodiment;

FIG. 3 is a control block diagram of a first server of the driving diagnosis device shown in FIG. 2;

FIG. 4 is a functional block diagram of a second server shown in FIG. 3;

FIG. 5 is a control block diagram of a third server of the driving diagnosis device shown in FIG. 2;

FIG. 6 is a functional block diagram of a fourth server of the driving diagnosis device shown in FIG. 2;

FIG. 7 is a functional block diagram of the mobile terminal shown in FIG. 2;

FIG. 8 is a diagram showing a scene list;

FIG. 9 is a diagram showing an event list;

FIG. 10 is a flowchart showing a process executed by the second server;

FIG. 11 is a flowchart showing a process executed by the fourth server;

FIG. 12 is a flowchart showing a process executed by the mobile terminal shown in FIG. 2;

FIG. 13 is a diagram showing an image displayed on a display unit of the mobile terminal; and

FIG. 14 is a diagram showing an image displayed on the display unit of the mobile terminal.

### DETAILED DESCRIPTION OF EMBODIMENTS

Hereinafter, embodiments of a driving diagnosis device 10 and a driving diagnosis method according to the present disclosure will be described with reference to the drawings.

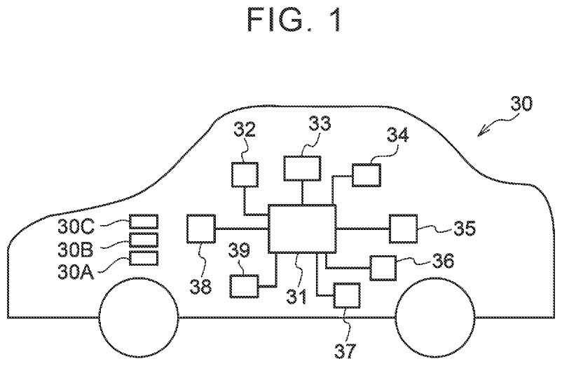

As shown in FIG. 1, a vehicle 30 capable of data communication with a driving diagnosis device 10 via a network includes an electronic control unit (ECU) 31, a wheel speed sensor 32, an accelerator operation amount sensor 33, a brake switch 34, a steering angle sensor 35, a turn signal switch 36, a global positioning system (GPS) receiver 37, a wireless communication device 38, and a camera 39. A vehicle ID is attached to the vehicle 30 capable of receiving a diagnosis by the driving diagnosis device 10. In the present embodiment, at least one vehicle 30 capable of receiving a diagnosis by the driving diagnosis device 10 is manufactured by a subject A. The wheel speed sensor 32, the accelerator operation amount sensor 33, the brake switch 34, the steering angle sensor 35, the turn signal switch 36, the GPS receiver 37, the wireless communication device 38, and the camera 39 are connected to the ECU 31. The ECU 31 includes a central processing unit (CPU: processor), a read-only memory (ROM), a random access memory (RAM), a storage, a wireless communication interface (I/F), and an input-output I/F. The CPU, the ROM, the RAM, the storage, the communication I/F, and the input-output I/F of the ECU 31 are connected to each other so as to be able to communicate with each other via a bus. The above network includes a communication network of a telecommunications carrier and the Internet network. The wireless communication device 38 of the vehicle 30 and a mobile terminal (operation terminal) 50 described later perform data communication via the network. Further, as shown in FIG. 1, the vehicle 30 has an accelerator pedal 30A, a brake pedal 30B, and a turn signal lever 30C. The turn signal lever 30C can rotate from a predetermined neutral position (initial position) to a first position on the upper side and a second position on the lower side.

The wheel speed sensor 32, the accelerator operation amount sensor 33, the brake switch 34, the steering angle sensor 35, the turn signal switch 36, and the GPS receiver 37 are detection units that repeatedly detect, every time a predetermined amount of time elapses, a physical amount that changes based on at least one of traveling, steering, and braking of the vehicle 30 or a physical amount that changes due to a predetermined operation member (such as the accelerator pedal 30A, the brake pedal 30B, and the turn signal lever 30C) being operated. The vehicle 30 is provided with four wheel speed sensors 32. Each wheel speed sensor 32 detects a wheel speed of corresponding one of the four wheels of the vehicle 30. The accelerator operation amount sensor 33 detects the accelerator operation amount that changes when the accelerator pedal 30A is stepped on. The brake switch 34 is turned ON and outputs a detection signal when the brake pedal 30B is stepped on with an operation amount equal to or more than a predetermined value, and is turned OFF when the operation amount of the brake pedal 30B is less than the predetermined value (does not output the detection signal). When the brake switch 34 outputs the detection signal, a brake device (not shown) provided in the vehicle 30 is activated and a brake lamp (not shown) is turned on under the control of the ECU 31. The steering angle sensor 35 detects a steering angle of a steering wheel. The turn signal switch 36 detects the operation of the turn signal lever 30C. For example, when the turn signal switch 36 detects that the turn signal lever 30C has been moved from the neutral position to the first position, a left side direction indicator (not shown) provided in the vehicle 30 is turned on under the control of the ECU 31. In contrast, when the turn signal switch 36 detects that the turn signal lever 30C has been moved to the second position, a right side direction indicator (not shown) provided in the vehicle 30 is turned on under the control of the ECU 31. By receiving a GPS signal transmitted from a GPS satellite, the GPS receiver 37 acquires information of a position where the vehicle 30 is traveling (hereinafter, referred to as “position information”). The detection values detected by the wheel speed sensor 32, the accelerator operation amount sensor 33, the brake switch 34, the steering angle sensor 35, the turn signal switch 36, and the GPS receiver 37 are transmitted to the ECU 31 via a controller area network (CAN) provided in the vehicle 30 and are stored in a storage of the ECU 31. Further, the camera 39 repeatedly captures an object positioned outside the vehicle 30 every time a predetermined amount of time elapses. The image data acquired by the camera 39 is transmitted to the ECU 31 via the network provided in the vehicle 30 and is stored in the storage.

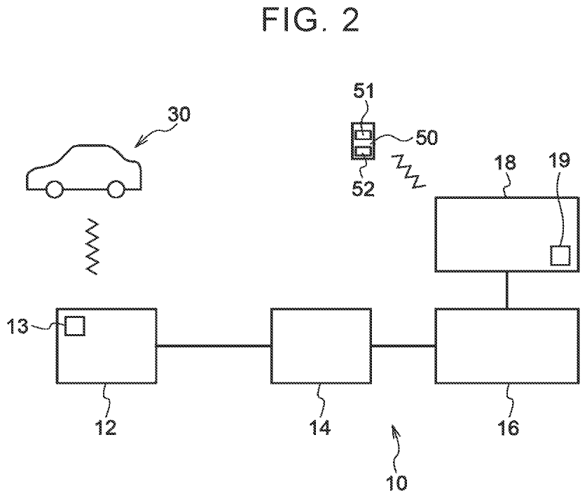

As shown in FIG. 2, the driving diagnosis device 10 includes a first server 12, a second server 14, a third server (database unit) 16, and a fourth server 18. For example, the first server 12, the second server 14, the third server 16, and the fourth server 18 are arranged in one building. The first server 12 and the fourth server 18 are connected to the above network. The first server 12 and the second server 14 are connected by a local area network (LAN). The second server 14 and the third server 16 are connected by a LAN. The third server 16 and the fourth server 18 are connected by a LAN. That is, the driving diagnosis device 10 is constructed as a cloud computing system. In the present embodiment, the first server 12, the second server 14, and the third server 16 are managed by the subject A. In contrast, the fourth server 18 is managed by a subject B.

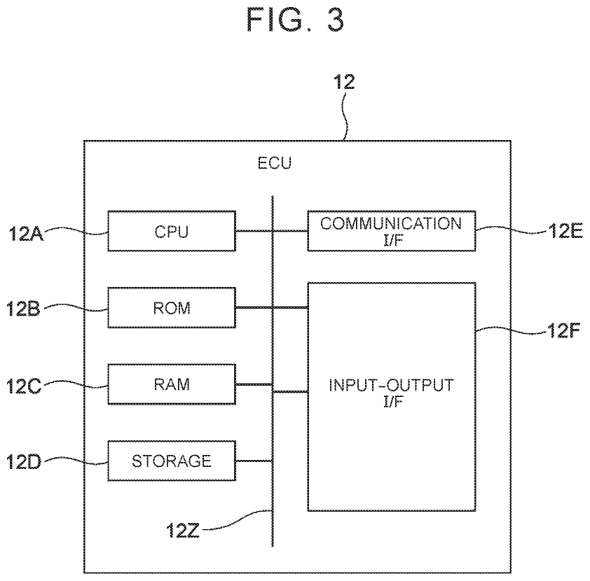

The first server 12 shown in FIG. 3 is configured to include a CPU 12A, a ROM 12B, a RAM 12C, a storage (detection value storing unit) 12D, a wireless communication OF 12E, and an input-output OF 12F. The CPU 12A, the ROM 12B, the RAM 12C, the storage 12D, the wireless communication OF 12E, and the input-output OF 12F are connected so as to be able to communicate with each other via a bus 12Z. The first server 12 can acquire information of the date and time from a timer (not shown).

The CPU 12A is a central processing unit that executes various programs and that controls various units. That is, the CPU 12A reads the program from the ROM 12B or the storage 12D and executes the program using the RAM 12C as a work area. The CPU 12A controls each configuration and performs various arithmetic processes (information processes) in accordance with the program recorded in the ROM 12B or the storage 12D.

The ROM 12B stores various programs and various data. The RAM 12C temporarily stores a program or data as a work area. The storage 12D is composed of a storage device such as a hard disk drive (HDD) or a solid state drive (SSD), and stores various programs and various data. The communication OF 12E is an interface for first server 12 to communicate with other devices. The input-output OF 12F is an interface for communicating with various devices.

The detection value data that is the data representing the detection values detected by the wheel speed sensor 32, the accelerator operation amount sensor 33, the brake switch 34, the steering angle sensor 35, the turn signal switch 36, and the GPS receiver 37 of the vehicle 30, and the image data acquired by the camera 39 is transmitted from the wireless communication device 38 to a transmission-reception unit 13 of the first server 12 via the above-described network every time a predetermined amount of time elapses, and the detection value data and the image data are recorded in the storage 12D. All the detection value data and image data recorded in the storage 12D include information of a vehicle ID, information of an acquired time, and position information acquired by the GPS receiver 37. That is, the detection value data and the image data are associated with the information of the vehicle ID, the information of the time, and the position information.

The basic configurations of the second server 14, the third server 16, and the fourth server 18 are the same as those of the first server 12.

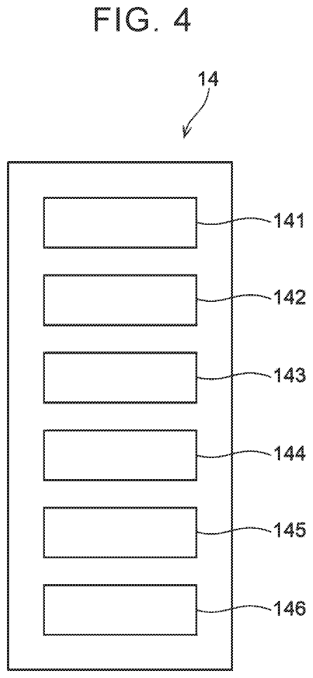

FIG. 4 shows an example of a functional configuration of the second server 14 by a block diagram. The second server 14 has a transmission-reception unit 141, a scene extraction unit 142, a (key performance indicator) KPI acquisition unit 143, a score calculation unit 144, an event identification unit 145, and a deletion unit 146 as functional configurations. The transmission-reception unit 141, the scene extraction unit 142, the KPI acquisition unit 143, the score calculation unit 144, the event identification unit 145, and the deletion unit 146 are realized by the CPU of the second server 14 reading and executing the program stored in the ROM.

The transmission-reception unit 141 transmits and receives information to and from the first server 12 and the third server 16 via the LAN. The detection value data and the image data recorded in the storage 12D of the first server 12 are transmitted to the transmission-reception unit 141 of the second server 14 while being associated with the vehicle ID, the time information, and the position information. The detection value data and the image data transmitted from the first server 12 to the transmission-reception unit 141 include a data group acquired during a predetermined data detection period. This data detection period is, for example, 30 minutes. Hereinafter, the data group (detection value data and image data) that corresponds to one vehicle ID and that is acquired during the data detection period will be referred to as a “detection value data group”. The detection value data group recorded in the first server 12 is transmitted to the transmission-reception unit 141 in order from the oldest acquired time. More specifically, as will be described later, when the detection value data group is deleted from the storage of the second server 14, a newer detection value data group than the detection value data group is transmitted from the first server 12 to the transmission-reception unit 141 and this new detection value data group is stored in the storage of the second server 14.

The scene extraction unit 142 identifies the detection value data group stored in the storage of the second server 14 into data representing the specific detection value and other data. More specifically, the scene extraction unit 142 treats the data necessary for acquiring the KPI, which will be described later, as the data representing the specific detection value.

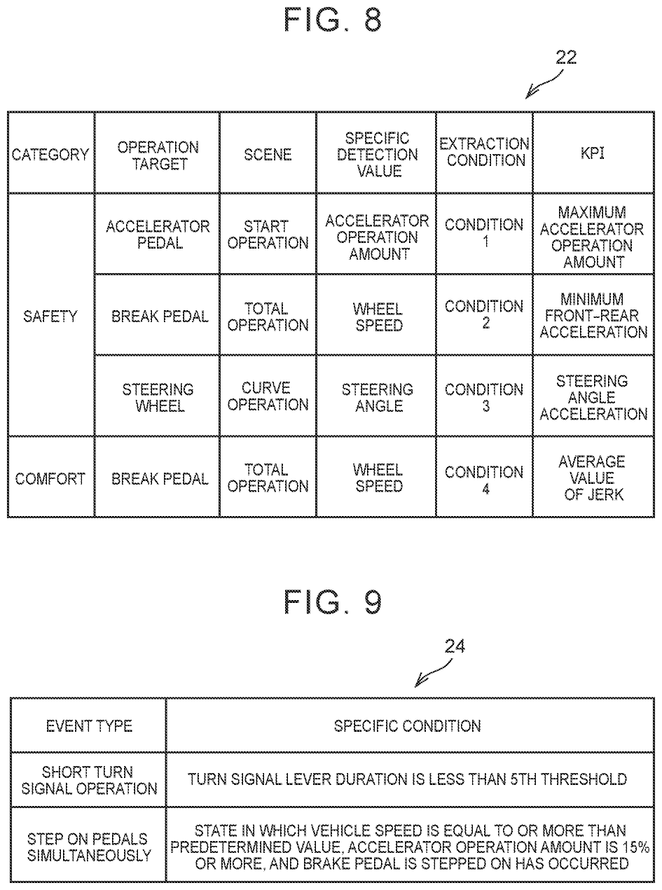

FIG. 8 is a scene list 22 recorded in the ROM of the second server 14. The scene list 22 is defined based on an operation target that is a member operated by a driver of the vehicle 30, operation content of the operation target, and the like. The categories that are the largest items in the scene list 22 are “safety” and “comfort”. Further, the operation targets included in the category “safety” are the accelerator pedal, the brake pedal, and the steering wheel. The operation target included in the category “comfort” is the brake pedal. Scenes, specific detection values, and extraction conditions are specified for each operation target.

For example, when it is determined that the accelerator pedal has been operated based on the detection value of the accelerator operation amount sensor 33 in a state in which an extraction condition 1 included in the category “safety” is satisfied, the scene extraction unit 142 refers to the scene list 22 and determines that “a start operation is being performed using the accelerator pedal”. The extraction condition 1 is, for example, that the vehicle speed of the vehicle 30 is equal to or more than a predetermined first threshold value. The vehicle speed of the vehicle 30 is calculated by the scene extraction unit 142 based on the wheel speed that is included in the detection value data group stored in the storage of the second server 14 and that is detected by each wheel speed sensor 32. Further, the scene extraction unit 142 determines whether the extraction condition 1 is satisfied based on the calculated vehicle speed and the first threshold value. When it is determined that the extraction condition 1 is satisfied, the scene extraction unit 142 extracts, as data indicating a specific detection value, data related to the accelerator operation amount detected by the accelerator operation amount sensor 33 in the time zone when the extraction condition 1 is satisfied, from the detection value data group stored in the storage.

When it is determined that the brake pedal has been operated based on the detection value of the brake switch 34 in a state in which the extraction condition 2 included in the category “safety” is satisfied, the scene extraction unit 142 refers to the scene list 22 and determines that “a total operation is being performed by using the brake pedal.” The extraction condition 2 is, for example, that the vehicle speed of the vehicle 30 is equal to or more than a predetermined second threshold value. The scene extraction unit 142 determines whether the extraction condition 2 is satisfied based on the calculated vehicle speed and the second threshold value. When it is determined that the extraction condition 2 is satisfied, the scene extraction unit 142 extracts, as data indicating the specific detection value, data related to the wheel speed detected by the wheel speed sensor 32 in the time zone when the extraction condition 2 is satisfied, from the detection value data group stored in the storage.

When it is determined that the steering wheel is operated based on the detection value of the steering angle sensor 35 in a state in which the extraction condition 3 included in the category “safety” is satisfied, the scene extraction unit 142 refers to the scene list 22 and determines that “a curve operation of the steering wheel is performed.” The extraction condition 3 is, for example, that the steering angle (steering amount) of the steering wheel within a predetermined amount of time is equal to or more than a predetermined third threshold value. The scene extraction unit 142 determines that the extraction condition 3 is satisfied based on the information of the steering angle that is included in the detection value data group stored in the storage of the second server 14 and that is detected by the steering angle sensor 35, and based on the third threshold value. When it is determined that the extraction condition 3 is satisfied, the scene extraction unit 142 extracts, as data indicating the specific detection value, data related to the steering angle detected by the steering angle sensor 35 in the time zone when the extraction condition 3 is satisfied, from the detection value data group stored in the storage.

When it is determined that the brake pedal has been operated based on the detection value of the brake switch 34 in a state in which the extraction condition 4 included in the category “comfort” is satisfied, the scene extraction unit 142 refers to the scene list 22 and determines that “a total operation is being performed by using the brake pedal.” The extraction condition 4 is, for example, that the vehicle speed of the vehicle 30 is equal to or more than a predetermined fourth threshold value. The scene extraction unit 142 determines whether the extraction condition 4 is satisfied based on the calculated vehicle speed and the fourth threshold value. When it is determined that the extraction condition 4 is satisfied, the scene extraction unit 142 extracts, as data indicating the specific detection value, data related to the wheel speed detected by the wheel speed sensor 32 in the time zone when the extraction condition 4 is satisfied, from the detection value data group stored in the storage.

When any of the extraction conditions are satisfied, the KPI acquisition unit 143 acquires (calculates) the KPI corresponding to the satisfied extraction condition.

For example, when the extraction condition 1 is satisfied, the KPI acquisition unit 143 acquires, as the KPI, the maximum accelerator operation amount in the time zone when the extraction condition 1 is satisfied, from the data (specific detection value) regarding the accelerator operation amount acquired by the scene extraction unit 142.

When the extraction condition 2 is satisfied, the KPI acquisition unit 143 calculates as the KPI, the minimum front-rear acceleration of the vehicle 30 in the time zone when the extraction condition 2 is satisfied, based on the data (specific detection value) related to the wheel speed acquired by the scene extraction unit 142. That is, the KPI acquisition unit 143 acquires a calculated value (derivative value) using the wheel speed as the KPI.

When the extraction condition 3 is satisfied, the KPI acquisition unit 143 calculates as the KPI, the steering angle in the time zone when the extraction condition 3 is satisfied, based on the data (specific detection value) related to the steering angle acquired by the scene extraction unit 142. That is, the KPI acquisition unit 143 acquires the calculated value (second derivative value) using the steering angle as the KPI.

When the extraction condition 4 is satisfied, the KPI acquisition unit 143 calculates as the KPI, the front-rear jerk of the vehicle 30 in the time zone when the extraction condition 4 is satisfied, based on the data (specific detection value) related to the wheel speed acquired by the scene extraction unit 142. That is, the KPI acquisition unit 143 acquires the calculated value (second derivative value) using the wheel speed as the KPI.

As will be described later, the score calculation unit 144 calculates the safety level score, the comfort level score, and the driving operation score based on the calculated KPI.

The event identification unit 145 identifies an event by referring to the detection value data group stored in the storage of the second server 14 and an event list 24 that is shown in FIG. 9 and that is recorded in the ROM of the second server 14. The event is a specific behavior that occurs in the vehicle 30 due to an operation by the driver. The event list 24 defines the type (content) of the event and the conditions (specific conditions) for being identified as an event. In the event list 24, a “short-time turn signal operation” and a “stepping on the pedals simultaneously” are defined as the events.

The event identification unit 145 determines whether the turn signal lever 30C has moved from the neutral position to the first position or the second position, based on all detection values of the turn signal switch 36 included in the detection value data group stored in the storage. The first position or the second position where the turn signal lever 30C has moved may be referred to as an “operation position”. Further, when the event identification unit 145 detects that the turn signal lever 30C has moved to the operation position, the event identification unit 145 determines whether a duration that is the amount of time during which the turn signal lever 30C is continuously positioned at the operation position is less than a predetermined fifth threshold value (threshold value), based on the information of the time at which the detection value of the turn signal switch 36 is acquired. When it is determined that the duration is less than the fifth threshold value, the event identification unit 145 identifies as the event, the date and time when the turn signal lever 30C is positioned at the operation position for the amount of time less than the fifth threshold value and the position information when this state occurs as an event. This fifth threshold value is determined based on, for example, a regulation of a country in which a road on which the vehicle 30 travels is present. For example, if the regulation of this country requires the driver to position the turn signal lever 30C in the operating position for 3 seconds or more, the fifth threshold value is “3 (seconds)”.

Whether the accelerator pedal 30A and the brake pedal 30B are stepped on simultaneously is determined by the event identification unit 145 based on all detection values (first detection value) of the accelerator operation amount sensor 33 and all detection values (second detection value) of the brake switch 34 included in the detection value data group stored in the storage. More specifically, the event identification unit 145 determines whether a state in which the vehicle speed of the vehicle 30 is equal to or more than a predetermined value, a state in which the accelerator operation amount that is the detection value of the accelerator operation amount sensor 33 is equal to or more than a predetermined value, and a state in which the brake switch 34 outputs the detection signal occur at the same time. When the accelerator pedal 30A and the brake pedal 30B are stepped on at the same time, an unnecessary large load may be applied to the brake device and a drive system of the vehicle 30. When it is determined that these states occur at the same time, the event identification unit 145 specifies the date and time of when this state had occurred and the position information of when this state had occurred as the event. The predetermined value of the vehicle speed in this case is, for example, “5 (km/h)”, and the predetermined value of the accelerator operation amount degree is, for example, “15%”.

When the scene extraction unit 142, the KPI acquisition unit 143, the score calculation unit 144, and the event identification unit 145 complete the above process for one detection value data group recorded in the storage, the safety level score, comfort level score, and driving operation score that are acquired and the data on the specified event are transmitted by the transmission-reception unit 141 to the third server 16 with information of the vehicle ID. The data related to this event includes information of the date and time of when each of the specified events had occurred, the position information, and the image data acquired by the camera 39 within a predetermined amount of time including the time of when the event had occurred.

When the scene extraction unit 142, the KPI acquisition unit 143, the score calculation unit 144, and the event identification unit 145 complete the above process for one detection value data group, the deletion unit 146 deletes the detection value data group from the storage of the second server 14.

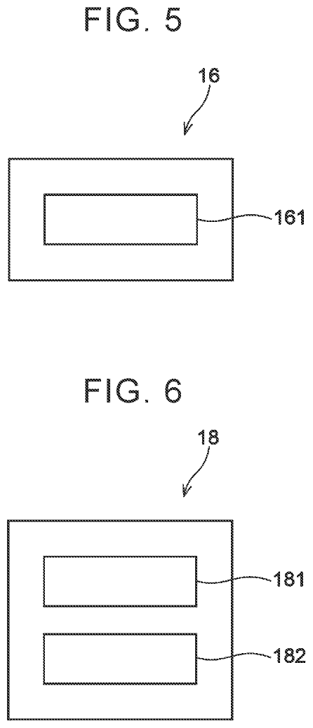

The third server 16 receives data related to the safety level score, the comfort level score, the driving operation score, and the identified event transmitted from the second server 14. As shown in FIG. 5, the third server 16 has a transmission-reception unit 161 as a functional configuration. The transmission-reception unit 161 is realized by the CPU of the third server 16 reading and executing the program stored in the ROM. The data received by the transmission-reception unit 161 are recorded in the storage of the third server 16. The data regarding the safety level score, the comfort level score, the driving operation score, and the specified event are sequentially transmitted from the second server 14 to the third server 16, and the third server 16 records all the received data in the storage.

The fourth server 18 at least functions as a Web server and a Web App server. As shown in FIG. 6, the fourth server 18 has a transmission-reception control unit 181 and a data generation unit 182 as a functional configuration. The transmission-reception control unit 181 and the data generation unit 182 are realized by the CPU of the fourth server 18 reading and executing the program stored in the ROM. The transmission-reception control unit 181 controls a transmission-reception unit 19 of the fourth server 18.

The mobile terminal 50 shown in FIG. 2 includes a CPU, a ROM, a RAM, a storage, a communication I/F, and an input-output I/F. The mobile terminal 50 is, for example, a smartphone or a tablet computer. The CPU, the ROM, the RAM, the storage, the communication I/F, and the input-output I/F of the mobile terminal 50 are connected to each other so as to be able to communicate with each other via a bus. The mobile terminal 50 can acquire information of the date and time from a timer (not shown). The mobile terminal 50 is provided with a display unit 51 having a touch panel. The display unit 51 is connected to an input-output I/F of the mobile terminal 50. Further, map data is recorded in the storage of the mobile terminal 50. The mobile terminal 50 has a transmission-reception unit 52.

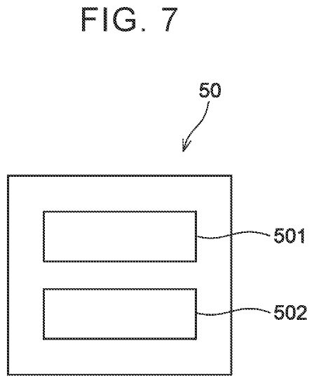

FIG. 7 shows an example of a functional configuration of the mobile terminal 50 by a block diagram. The mobile terminal 50 has a transmission-reception control unit 501 and a display unit control unit 502 as a functional configuration. The transmission-reception control unit 501 and the display unit control unit 502 are realized by the CPU reading and executing the program stored in the ROM. The mobile terminal 50 is owned by, for example, the driver of the vehicle 30 provided with the vehicle ID. A predetermined driving diagnosis display application is installed on the mobile terminal 50.

The transmission-reception unit 52 controlled by the transmission-reception control unit 501 transmits and receives data to and from the transmission-reception unit 19 of the fourth server 18.

The display unit control unit 502 controls the display unit 51. That is, the display unit control unit 502 causes the display unit 51 to display, for example, the information received from the transmission-reception unit 19 by the transmission-reception unit 52 and the information input via the touch panel. The information input by the touch panel of the display unit 51 can be transmitted by the transmission-reception unit 52 to the transmission-reception unit 19.

### Operation and Effects

Next, the operation and effects of this embodiment will be described.

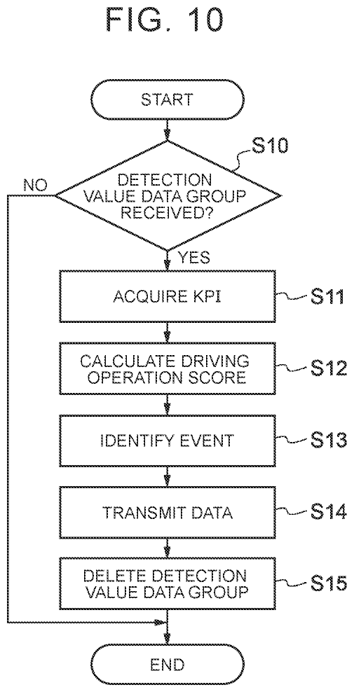

Next, the flow of the process performed by the second server 14 will be described by using the flowchart of FIG. 10. The second server 14 repeatedly executes the process of the flowchart of FIG. 10 every time a predetermined amount of time elapses.

First, in step S10, the transmission-reception unit 141 of the second server 14 determines whether the detection value data group has been received from the first server 12. In other words, the transmission-reception unit 141 determines whether the detection value data group is recorded in the storage of the second server 14.

When it is determined YES in step S10, the second server 14 proceeds to step S11, and the scene extraction unit 142 extracts data representing the specific detection value satisfying the extraction condition from the detection value data group stored in the storage. Further, the KPI acquisition unit 143 acquires (calculates) each KPI based on the data representing the extracted specific detection value.

The second server 14 that has completed the process of step S11 proceeds to step S12, and the score calculation unit 144 calculates the safety level score, the comfort level score, and the driving operation score.

For example, when the KPI (maximum accelerator operation amount) that is acquired when the extraction condition 1 of FIG. 8 is satisfied is a predetermined value or more, the score for this KPI is 5 points. In contrast, when this KPI is less than the predetermined value, the score for this KPI is 100 points.

For example, when the KPI (minimum front-rear acceleration) that is acquired when the extraction condition 2 of FIG. 8 is satisfied is less than a predetermined value, the score for this KPI is 5 points. In contrast, when this KPI is equal to or more than the predetermined value, the score for this KPI is 100 points.

For example, when the KPI (acceleration of the steering angle) that is acquired when the extraction condition 3 of FIG. 8 is satisfied is a predetermined value or more, the score for this KPI is 5 points. In contrast, when this KPI is less than the predetermined value, the score for this KPI is 100 points.

The value (average value) acquired by dividing the total score of each KPI corresponding to the extraction condition 1 to the extraction condition 3 by the number of items (3) in the category “safety” is the safety level score.

For example, when the KPI (average value of jerk) that is acquired when the extraction condition 4 of FIG. 8 is satisfied is a predetermined value or more, the safety level score for this KPI is 5 points. In contrast, when this KPI is less than the predetermined value, the safety level score for this KPI is 100 points.

The value (average value) that is acquired by dividing the total score of the KPI of the category “comfort” by the number of items of the category “comfort” is the comfort level score. However, in the present embodiment, since the number of items in the category “comfort” is “1”, the score related to the KPI corresponding to the extraction condition 4 is the comfort level score.

Further, the score calculation unit 144 calculates the driving operation score based on the calculated safety level score and comfort level score. Specifically, the score calculation unit 144 acquires the value (average value) obtained by dividing the total score of the safety level score and the comfort level score by the sum (4) of the items of the safety level score and the comfort level score as the driving operation score.

The second server 14 that has completed the process of step S12 proceeds to step S13, and the event identification unit 145 identifies an event based on the detection value data group stored in the storage of the second server 14.

The second server 14 that has completed the process of step S13 proceeds to step S14, and the transmission-reception unit 141 sends data on the safety level score, the comfort level score, the driving operation score, and the specified event to the third server 16 together with the information of the vehicle ID.

The second server 14 that has completed the process of step S14 proceeds to step S15, and the deletion unit 146 deletes the detection value data group from the storage of the second server 14.

When the determination “NO” is made in step S10, or when the process of step S15 is completed, the second server 14 temporarily ends the process of the flowchart of FIG. 10.

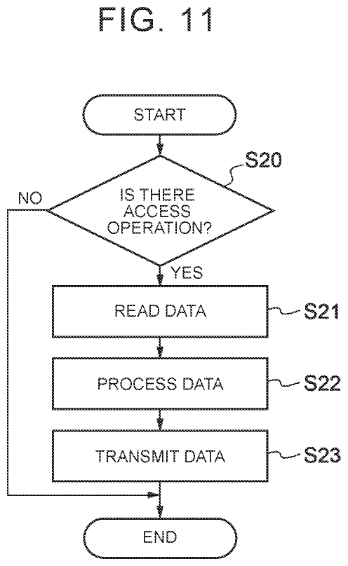

Next, the flow of the process performed by the fourth server 18 will be described with reference to the flowchart of FIG. 11. The fourth server 18 repeatedly executes the process of the flowchart of FIG. 11 every time a predetermined amount of time elapses.

First, in step S20, the transmission-reception control unit 181 of the fourth server 18 determines whether a display request has been transmitted to the transmission-reception unit 19 from the transmission-reception control unit 501 (transmission-reception unit 52) of the mobile terminal 50 in which the driving diagnosis display application is activated. That is, the transmission-reception control unit 181 determines whether there is an access operation from the mobile terminal 50. This display request includes information of the vehicle ID associated with the mobile terminal 50.

When it is determined YES in step S20, the fourth server 18 proceeds to step S21, and the transmission-reception control unit 181 (transmission-reception unit 19) communicates with the third server 16. The transmission-reception control unit 181 (transmission-reception unit 19) receives from the transmission-reception unit 161 of the third server 16, the data regarding the safety level score, the comfort level score, the driving operation score, and the specified event corresponding to the vehicle ID associated with the mobile terminal 50 that transmitted the display request.

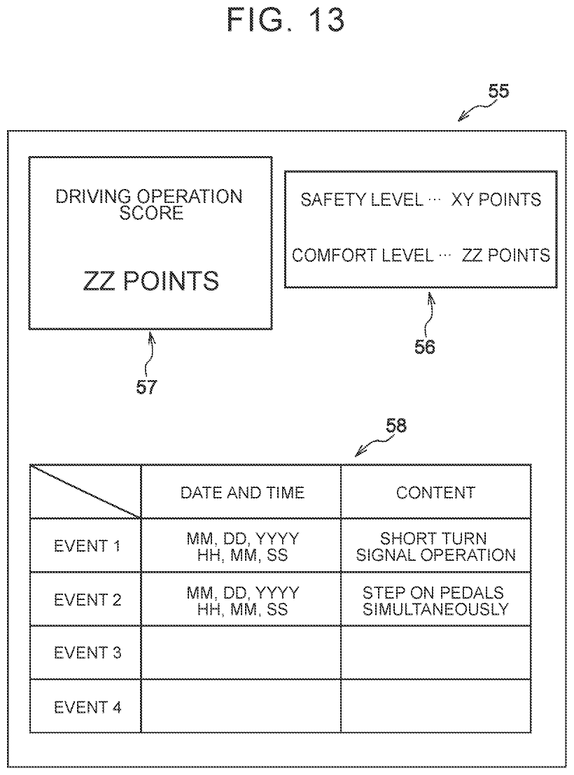

The fourth server 18 that has completed the process of step S21 proceeds to step S22, and the data generation unit 182 generates data representing a driving diagnosis result image 55 (see FIG. 13) using the data received in step S21. The driving diagnosis result image 55 can be displayed on the display unit 51 of the mobile terminal 50 in which the driving diagnosis display application is activated.

The fourth server 18 that has completed the process of step S22 proceeds to step S23, and the transmission-reception unit 19 transmits the data generated by the data generation unit 182 in step S22 to the transmission-reception control unit 501 (transmission-reception unit 52) of the mobile terminal 50.

When the determination “NO” is made in step S20, or when the process of step S23 is completed, the fourth server 18 temporarily ends the process of the flowchart of FIG. 11.

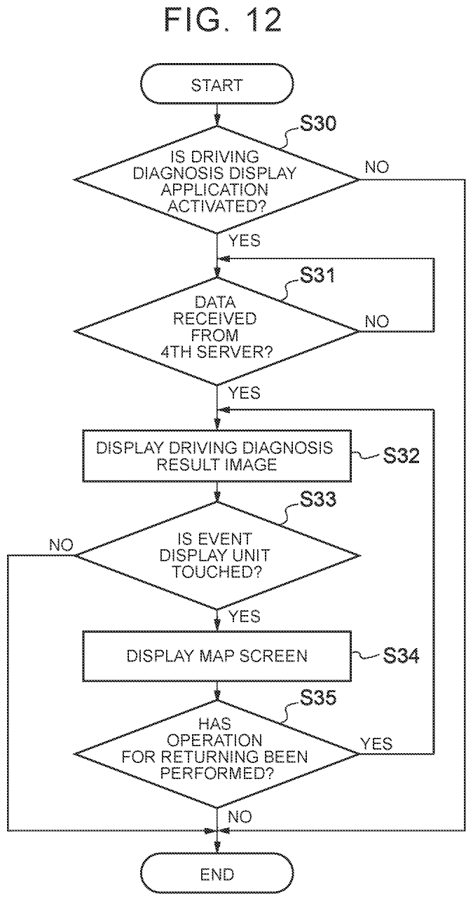

Next, the flow of the process performed by the mobile terminal 50 will be described with reference to a flowchart of FIG. 12. The mobile terminal 50 repeatedly executes the process of the flowchart of FIG. 12 every time a predetermined amount of time elapses.

In step S30, the display unit control unit 502 of the mobile terminal 50 determines whether the driving diagnosis display application is running.

When it is determined YES in step S30, the mobile terminal 50 proceeds to step S31, and determines whether the transmission-reception control unit 501 (transmission-reception unit 52) has received data representing the driving diagnosis result image 55 from the transmission-reception unit 19 of the fourth server 18.

When the determination “YES” is made in step S31, the mobile terminal 50 proceeds to step S32, and the display unit control unit 502 causes the display unit 51 to display the driving diagnosis result image 55.

As shown in FIG. 13, the driving diagnosis result image 55 has a safety-comfort level display unit 56, a score display unit 57, and an event display unit 58. A safety level score and a comfort level score are displayed on the safety-comfort level display unit 56. The driving operation score is displayed on the score display unit 57. Information of each specified event is displayed on the event display unit 58. The information representing each event includes the date and time when the event occurred and the content.

The mobile terminal 50 that has completed the process of step S32 proceeds to step S33, and the display unit control unit 502 determines whether a hand of a user of the mobile terminal 50 has touched the event display unit 58 on the display unit 51 (touch panel).

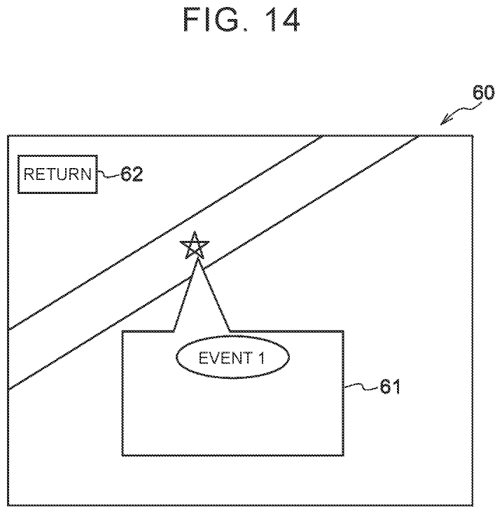

When it is determined YES in step S33, the mobile terminal 50 proceeds to step S34, and the display unit control unit 502 causes the display unit 51 to display a map image 60 based on the map data shown in FIG. 14. Here, it is assumed that the driver touches the “event 1” in the event display unit 58. In this case, the map image 60 includes map information of the place where the event 1 has occurred and its surroundings, and the place where the event 1 has occurred is indicated by a star mark. Further, when the user touches the star mark, the event image 61 represented by the image data acquired by the camera 39 within a predetermined amount of time including the time when the event 1 occurs is displayed. This predetermined amount of time is, for example, 10 seconds.

The mobile terminal 50 that has completed the process of step S34 proceeds to step S35, and the display unit control unit 502 determines whether the return operation unit 62 on the map image 60 has been touched by the user's hand. When the determination “YES” is made in step S35, the display unit control unit 502 of the mobile terminal 50 proceeds to step S32, and causes the display unit 51 to display the driving diagnosis result image 55.

When the determination “NO” is made in step S30, step S33, or step S35, the mobile terminal 50 temporarily ends the process of the flowchart of FIG. 12.

As described above, in the system 10 and the driving diagnosis method of the present embodiment, when the event identification unit 145 determines that the duration during which the turn signal lever 30C is positioned at the operation position is less than the fifth threshold value, information indicating that the duration is less than the fifth threshold value is included in the driving diagnosis result image 55. Thus, the system 10 and the driving diagnosis method of the present embodiment can motivate the driver that has recognized that the duration is less than the fifth threshold by looking at the driving diagnosis result image 55 to suppress the duration of the turn signal lever 30C from becoming less than the fifth threshold when moving the turn signal lever 30C to the operation position thereafter.

Further, in the system 10 and the driving diagnosis method of the present embodiment, when the event identification unit 145 determines that the accelerator pedal 30A and the brake pedal 30B are stepped on at the same time, the information that the accelerator pedal 30A and the brake pedal 30B are stepped on at the same time is included in the driving diagnosis result image 55. Thus, the system 10 and the driving diagnosis method of the present embodiment can motivate the driver that has recognized that the accelerator pedal 30A and the brake pedal 30B are stepped on simultaneously by looking at the driving diagnosis result image 55 to refrain from stepping on the accelerator pedal 30A and the brake pedal 30B at the same time when performing driving operation of the vehicle 30 thereafter.

Further, the image data included in the data group transmitted from the second server 14 to the third server 16 is only the image data when the event occurs. Therefore, the amount of data accumulated in the storage of the third server 16 is smaller than the case where all the image data recorded in the storage of the second server 14 is transmitted from the second server 14 to the third server 16.

Further, in the driving diagnosis device 10 and the driving diagnosis method of the present embodiment, the driving diagnosis is performed using the driving operation score (KPI) and the event. Therefore, the driver who sees the driving diagnosis result image 55 can recognize the characteristics of their driving operation from a wide range of viewpoints.

Further, the KPI acquisition unit 143 calculates the KPI using only the specific detection value in the detection value data group. Thus, a calculation load of the KPI acquisition unit 143 is smaller than that in the case where the KPI calculation is performed using all of the detection value data groups. Therefore, the calculation load of the driving diagnosis device 10 and the driving diagnosis method of the present embodiment is small.

Further, in the driving diagnosis device 10 and the driving diagnosis method of the present embodiment, the subject B different from the subject A that manages the first server 12, the second server 14, and the third server 16 and that manufactures the vehicle can access the data stored in the third server 16. Thus, a person (organization) different from the subject A can create an application (driving diagnosis display application) that uses the driving diagnosis result acquired by the driving diagnosis device 10 and the driving diagnosis method of the present embodiment. Therefore, development of such an application can be promoted.

Although the driving diagnosis device 10 and the driving diagnosis method according to the embodiment have been described above, the design of the driving diagnosis device 10 and the driving diagnosis method can be appropriately changed within a range not deviating from the scope of the present disclosure.

For example, the event identification unit 145 may determine whether a state in which the accelerator operation amount that is the detection value of the accelerator operation amount sensor 33 is equal to or more than a predetermined value and a state in which the brake switch 34 outputs the detection signal occur at the same time. In other words, the event identification unit 145 may determine whether the accelerator pedal 30A and the brake pedal 30B are stepped on simultaneously without considering the vehicle speed of the vehicle 30.

The vehicle 30 may include a sensor (not shown) that detects the pressure (hydraulic pressure) of a brake hydraulic fluid in a master cylinder that operates when the brake pedal 30B is stepped on. Then, when the hydraulic pressure detected by this sensor is equal to or more than a predetermined value, the event identification unit 145 may determine that “the brake pedal 30B has been stepped on”. The predetermined value is, for example, 0.07 MPa.

The categories, operation targets, scenes, specific detection values, extraction conditions and KPIs shown in FIG. 8 are not limited to those shown in FIG. 8. For example, there may be a plurality of operation targets, scenes, specific detection values, extraction conditions, and KPIs of the category “comfort”.

The types of events described in FIG. 9 are not limited to those described in FIG. 9. The event list 24 may include other events in addition to the “short-time turn signal operation” and the “stepping on the pedals simultaneously”. For example, at least one of sudden steering occurrence, antilock brake system (ABS) activation, pre-crash safety system (PCS) activation, and detection of collision with an obstacle may be specified as the event by the event identification unit 145.

The driving diagnosis device 10 may be implemented with a configuration different from the above. For example, the first server 12, the second server 14, the third server 16, and the fourth server 18 may be realized by one server. In this case, for example, by using a hypervisor, the inside of the server may be virtually divided into areas corresponding to the first server 12, the second server 14, the third server 16, and the fourth server 18.

The detection unit that acquires the detection value data group may be any device as long as it acquires a physical amount that changes based on at least one of traveling, steering, and braking of the vehicle or a physical quantity that changes when a predetermined operating member is operated. For example, this detection unit may be a sensor for measuring a coolant temperature of an engine, a yaw rate sensor, a shift lever position sensor, or the like. Moreover, the number of detection units may be any number.

The driving diagnosis device 10 may not acquire the driving operation score, but may acquire only the event. In this case, only the event is stored in the storage of the third server 16.

The KPI acquisition (calculation) method and the driving operation score calculation method may be different from the above methods. For example, the safety level score and the comfort level score may be calculated while weighting each KPI.

The driving diagnosis device 10 does not have to be connected to the Internet. In this case, for example, the detection value data group acquired from the vehicle is recorded on a portable recording medium (for example, a USB), and the detection value data group in the recording medium is copied to the first server 12.

The third server 16 may have a function of confirming the access authority when the third server 16 receives an access from the fourth server 18. In this case, only when the third server 16 confirms that the fourth server 18 has the access authority, the fourth server 18 receives the data regarding the safety level score, the comfort level score, the driving operation score, and the specified event from the third server 16.

A constant restriction may be applied to the access by the subject B (fourth server 18) to a part of the data recorded in the storage of the third server 16. For example, information indicating that the data is a restriction target is added to a part of the data group recorded in the storage of the third server 16. Access by the subject B (fourth server 18) to the data to which the information indicating that the access is the restriction target is added is prohibited (even when the user has the above access authority). The data to which the information indicating that the access is the restriction target is added is, for example, position information.

Instead of the GPS receiver 37, the vehicle 30 may include a receiver capable of receiving information from satellites of a global navigation satellite system (for example, Galileo) other than GPS.

The mobile terminal 50 may read the map data from the Web server and display the map image on the display unit 51.

What is claimed is:

1. A driving diagnosis device comprising an event identification unit that is able to acquire, from a vehicle, a first detection value indicating that an accelerator pedal provided on the vehicle is stepped on and a second detection value indicating that a brake pedal provided on the vehicle is stepped on, and that determines whether the accelerator pedal and the brake pedal are simultaneously stepped on based on the acquired first detection value and the acquired second detection value.

2. The driving diagnosis device according to claim 1, further comprising a transmission-reception unit that is able to receive the first detection value and the second detection value from the vehicle via an Internet and that is able to transmit the acquired first detection value and the acquired second detection value to the event identification unit.

3. The driving diagnosis device according to claim 1, further comprising a database unit that stores information of whether the accelerator pedal and the brake pedal are stepped on simultaneously, the information being determined by the event identification unit, and that is connected to the Internet.

4. A driving diagnosis method comprising:
a step of acquiring, from a vehicle, a first detection value indicating that an accelerator pedal provided on the vehicle is stepped on and a second detection value indicating that a brake pedal provided on the vehicle is stepped on; and
a step of determining whether the accelerator pedal and the brake pedal are simultaneously stepped on based on the acquired first detection value and the acquired second detection value.
